(19) United States
(12) Patent Application Publication
(10) Pub. No.: US 2009/0284955 A1
(43) Pub. Date: Nov. 19, 2009

(54) CONNECTOR, BACKLIGHT MODULE, LIQUID CRYSTAL DISPLAY DEVICE AND METHOD FOR MANUFACTURING THE BACKLIGHT MODULE

(75) Inventors: Po Chun CHEN, Rueifang Township (TW); Wei Jung CHAN, Pingjhen City (TW); Cheng Chia WU, Banciao City (TW)

Correspondence Address: LOWE HAUPTMAN HAM & BERNER, LLP, 1700 DIAGONAL ROAD, SUITE 300, ALEXANDRIA, VA, 22314, US

(73) Assignee: HANNSTAR DISPLAY CORP., TAIPEI COUNTY (TW)

(21) Appl. No.: 12/370,155

(22) Filed: Feb. 12, 2009

(30) Foreign Application Priority Data
May 14, 2008 (TW) 097117666

(51) Int. Cl. G02F 1/13357; G09F 13/04

(52) U.S. Cl. 362/97.2; 362/97.1

(57) ABSTRACT

A backlight module includes a housing and at least one connector. The housing includes a bottom plate, which includes an upper surface, a lower surface and at least one through opening. The connector includes an upper portion, a middle portion and a lower portion, wherein the lower portion is disposed within the through hole and is provided with an electrically conductive contact, the middle portion is located between the upper portion and the lower portion, and the middle portion is disposed over the upper surface of the bottom plate.

### CROSS REFERENCE TO RELATED APPLICATION

This application claims the priority benefit of Taiwan Patent Application Serial Number 097117666, filed on May 14, 2008, the full disclosure of which is incorporated herein by reference.

### BACKGROUND OF THE INVENTION

1. Field of the Invention

The present invention generally relates to a liquid crystal display device, and more particularly to a backlight module of a liquid crystal display device, wherein it is not necessary to redesign a new connector having different height or size, when the distance between the lamp and the bottom plate is requested to be different or the distance between the printed circuit board of the inverter and the bottom plate is requested to be different.

2. Description of the Related Art

Referring to FIG. 1, it depicts a conventional liquid crystal display (LCD) device 10. The liquid crystal display device 10 includes a liquid crystal panel 12 and a backlight module 16. The backlight module 16 is disposed under the liquid crystal panel 12 for distributing the light from a light source uniformly over the liquid crystal panel 12. The liquid crystal display device 10 further includes a front frame 14 for mounting the liquid crystal panel 12 and the back light module 16.

Referring to FIG. 2, it depicts a conventional direct type backlight module 20. The backlight module 20 includes a housing 22, a plurality of lamps 28 (e.g. cold cathode fluorescent lamps, CCFLs) and a plurality of optical films 24. The housing 22 has a bottom plate 26 for supporting the lamps 28, whereby the lamps 28 are disposed in the housing 22. The optical films 24 (e.g. a diffusing sheet and a prism sheet) are disposed above the lamps 28.

Referring to FIG. 3, it depicts a conventional liquid crystal display device 50. The liquid crystal display device 50 includes a liquid crystal panel 51 and a backlight module 52. The backlight module 52 disposed under the liquid crystal panel 51 and includes a housing 55, a plurality of lamps 53 (e.g. cold cathode fluorescent lamps, CCFLs) and an inverter 60. The lamps 53 are disposed in the housing 55. The housing 55 has a bottom plate 56 for supporting the lamps 53 and carrying the inverter 60. The inverter 60 includes a printed circuit board 57, a transformer 59 and a casing 63. The printed circuit board 57 is disposed under the housing 55, and there is a gap kept between the printed circuit board 57 and the housing 55. The transformer 59 is disposed under and electrically connected to the printed circuit board 57. The casing 63 is disposed under the transformer 59 for covering the transformer 59 and the printed circuit board 57.

The inverter 60 is a DC/AC inverter applied to the backlight module 52 of the liquid crystal display device 50 for converting DC voltage into AC voltage. Simultaneously, the transformer 59 of the inverter 60 can boost the AC voltage to turn on the lamps 53 of the backlight module 52. As the size of the liquid crystal display device 50 becomes larger, the volumes of the transformer 59 and the inverter 60 are also increased.

Referring to FIGS. 4 and 5, they depict a conventional backlight module 70 having another kind of inverter 80. The backlight module 70 includes a housing 72, a plurality of lamps 74 and an inverter 80. The housing 72 has a bottom plate 76, which includes a plurality of through openings 78. The inverter 80 includes a printed circuit board 82, a plurality of connectors 84 and a transformer (not shown). The connectors 84 are soldered on the printed circuit board 82 and corresponding to the through openings 78.

The backlight module 70 is designed without soldering between lamps and connectors. A method for assembling the backlight module 70 includes steps as follows. First, the connectors 84 passes through the through openings 78 of the bottom plate 76, and a part of the connector 84 is protruded above the bottom plate 76 and has a predetermined height. Then, the printed circuit board 82 is mounted on the bottom plate 76 by a plurality of screws 86, whereby the bottom plate 76 can carry the inverter 80. Finally, a wire of the lamp 74 is hold in the connectors 84. The inverter 80 can convert DC voltage into AC voltage and boost the AC voltage to turn on the lamps 74.

However, backlight modules designed by every LCD device makers are different. For example, referring to FIG. 5, the distance e1 between the lamp 74 and the bottom plate 76 and the distance e2 between the inverter 80 and the printed circuit board 82 are different due to different design rules of the LCD device makers. Thus, a connector supplier must make connectors having different height or size due to different requirements of customers. For above reasons, the connectors having different height or size can increase the manufacture cost of connectors.

Accordingly, there exists a demand for providing an all-purposed connector capable of solving the above-mentioned problems.

### SUMMARY OF THE INVENTION

It is an object of the present invention to provide a backlight module, wherein it is not necessary to redesign a new connector having different height or size so as to be an all-purpose connector, when the distance between the lamp and the bottom plate is requested to be different or the distance between the printed circuit board of the inverter and the bottom plate is requested to be different.

In order to achieve the foregoing object, the present invention provides a backlight module including a housing and at least one connector. The housing includes a bottom plate, which includes an upper surface, a lower surface and at least one through opening. The connector includes an upper portion, a middle portion and a lower portion, wherein the lower portion is disposed within the through hole and is provided with a first electrically conductive contact, the middle portion is located between the upper portion and the lower portion, and the middle portion is disposed over the upper surface of the bottom plate. The backlight module further includes an inverter including a printed circuit board mounted on the lower surface of the bottom plate, the printed circuit board being provided with at least one second electrically conductive contact adapted to be connected to the first electrically conductive contact. The backlight module further includes at least one lamp having a wire, the wire being hold in the upper portion of the connector.

According to the connector of the present invention, when the distance between the lamp and the bottom plate is requested to be different or the distance between the printed circuit board of the inverter and the bottom plate is requested to be different, it is not necessary to redesign a new connector having different height or size. Simultaneously, it can be still sure that the electrical connection between the plug of the printed circuit board of the inverter and the socket of the connector is good. Compared with the prior art, the connector of the present invention is an all-purpose connector so as to decrease the manufacture cost of connectors.

The foregoing, as well as additional objects, features and advantages of the invention will be more apparent from the following detailed description, which proceeds with reference to the accompanying drawings.

### BRIEF DESCRIPTION OF THE DRAWINGS

FIG. 1 is an exploded perspective view of a liquid crystal display device in the prior art.

FIG. 2 is an exploded cross-sectional view of a direct type backlight module in the prior art.

FIG. 3 is an assembled cross-sectional view of a liquid crystal display device having an inverter in the prior art.

FIGS. 4 and 5 are exploded perspective and assembled cross-sectional view of another backlight module having an inverter in the prior art.

FIGS. 6 and 7 are exploded perspective and assembled cross-sectional view of a backlight module according to a first embodiment of the present invention.

FIG. 8 is a perspective view of a connector of the backlight module according to the first embodiment of the present invention.

FIG. 9 is a partially enlarged cross-sectional view of a backlight module according to a further embodiment of the present invention.

FIG. 10 is a partially enlarged cross-sectional view of a backlight module according to another embodiment of the present invention.

FIG. 11 is a partially enlarged cross-sectional view of a backlight module according to a second embodiment of the present invention.

FIG. 12 is a partially enlarged cross-sectional view of a backlight module according to a third embodiment of the present invention.

FIG. 13 is an exploded perspective view of a liquid crystal display device according to an embodiment of the present invention.

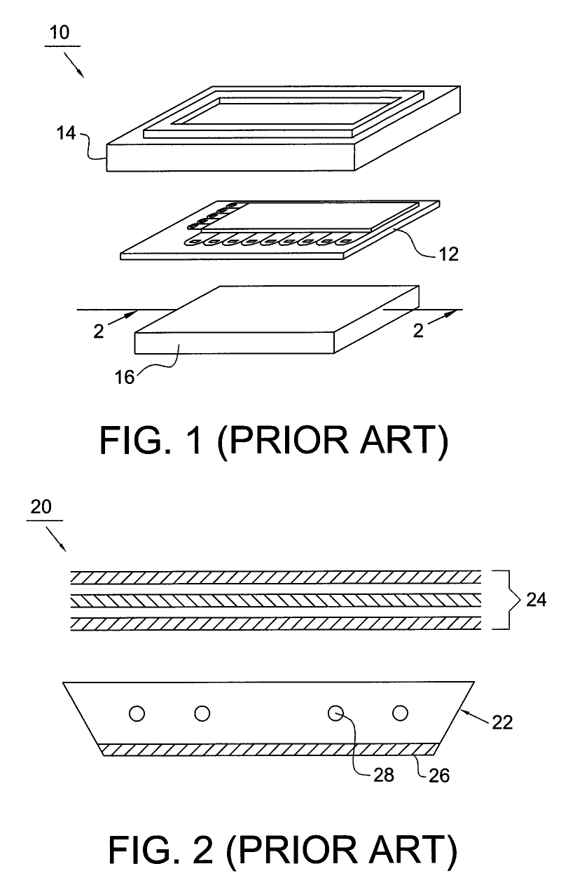

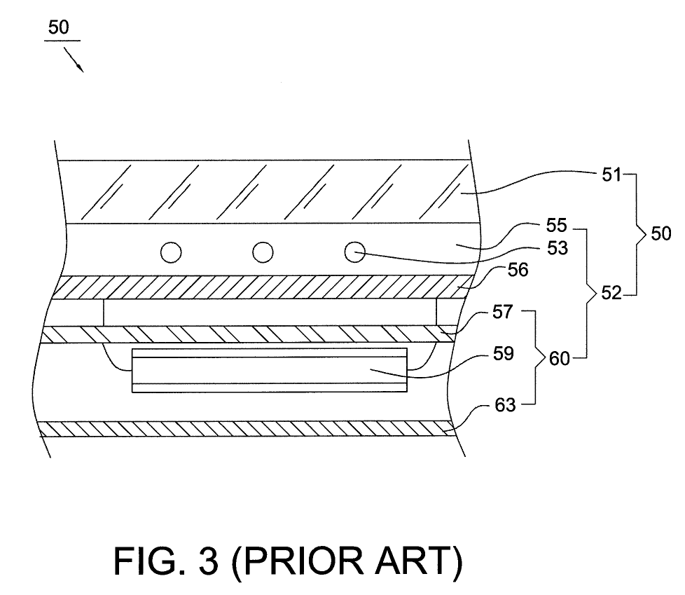

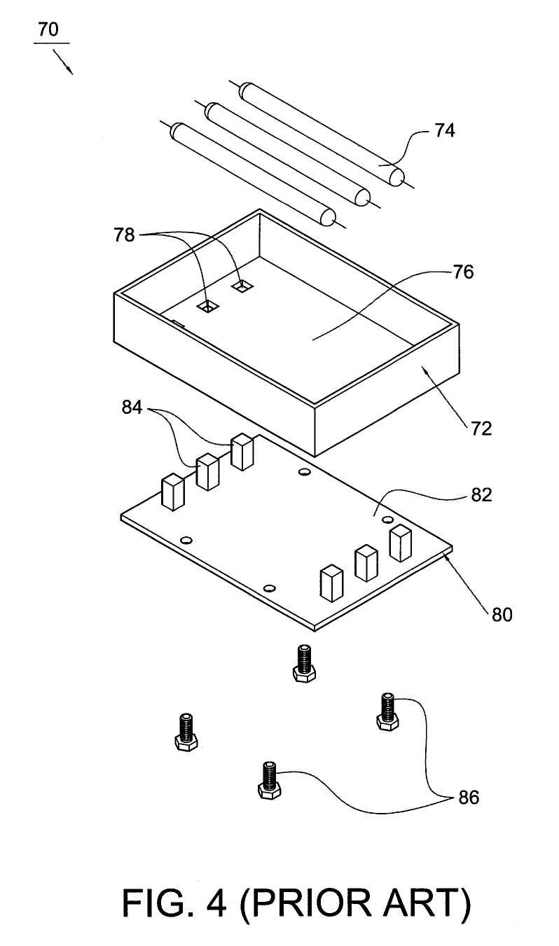

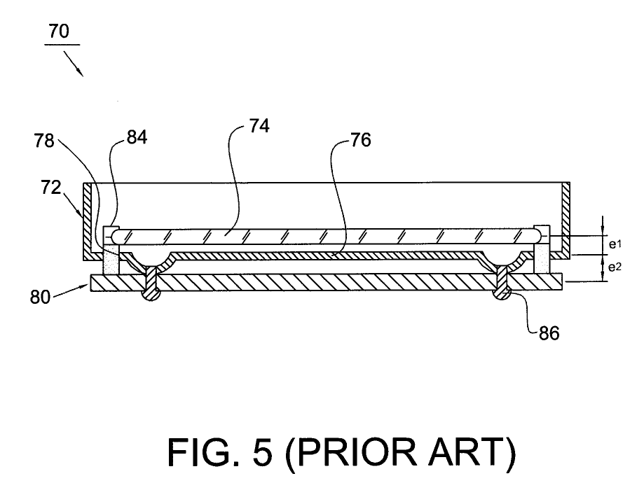

### DETAILED DESCRIPTION OF THE PREFERRED EMBODIMENT

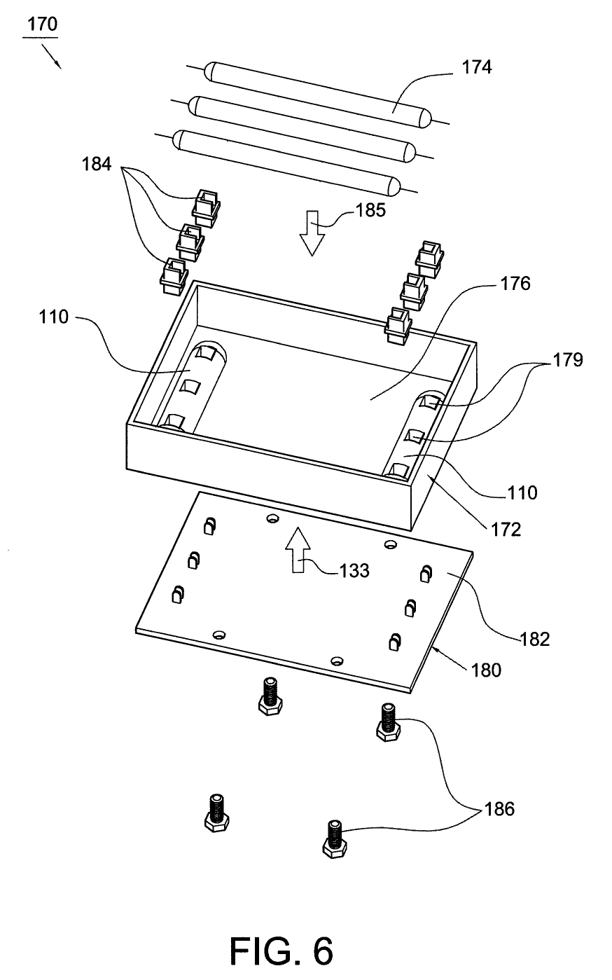

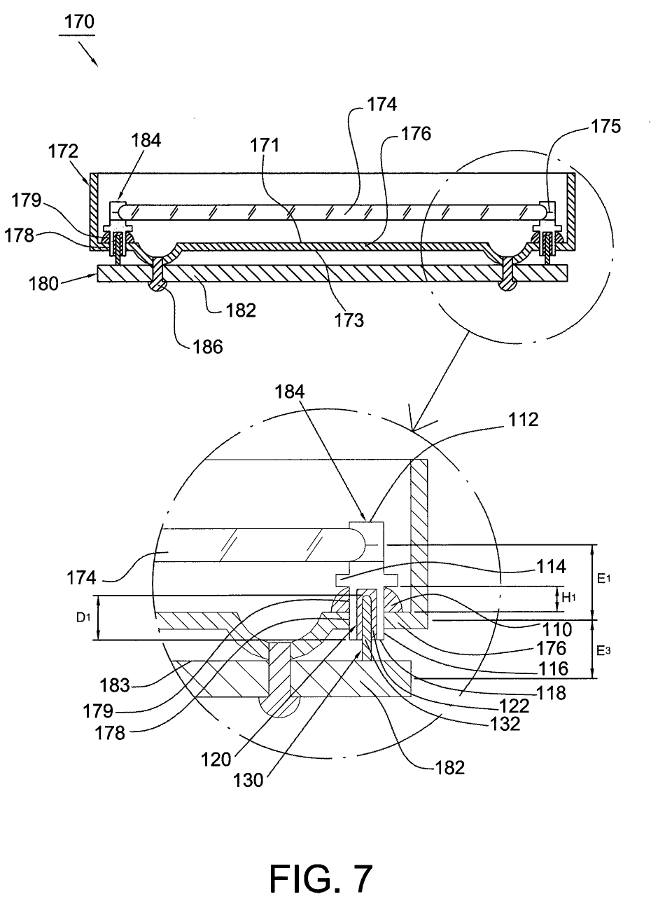

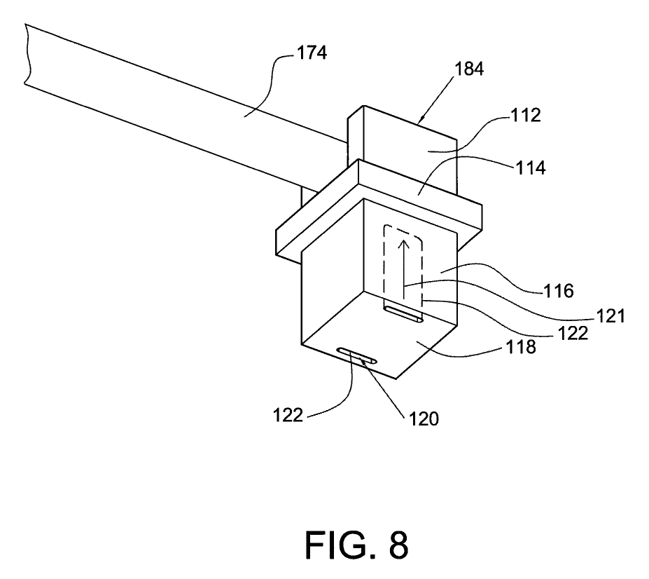

Referring to FIGS. 6 and 7, they depict a backlight module 170 according to a first embodiment of the present invention. The backlight module 170 includes a housing 172 and at least one connector 184. The housing 172 includes a bottom plate 176, which includes at least one first through opening 178. The first through opening 178 is extended from an upper surface 171 to a lower surface 173 of the bottom plate 176. At least one bump portion 110 is disposed on the upper surface 171 of the bottom plate 176, and includes at least one second through opening 179 communicated with the first through opening 178. The bump portion 110 is detachably mounted on the upper surface 171 of the bottom plate 176, or the bump portion 110 and the bottom plate 176 can be integrated formed. The connector 184 includes an upper portion 112, a middle portion 114 and a lower portion 116. At least one part of the lower portion 116 is disposed within the first and second through holes 178, 179 and is provided with a first electrically conductive contact 120, which is located on a bottom surface 118 of the lower portion 116 (shown in FIG. 8). The middle portion 114 is located between the upper portion 112 and the lower portion 116. The cross-sectional area of the middle portion 114 of the connector 184 is larger than those of the first and second through holes 178, 179 (i.e. the cross-sectional area of the middle portion 114 of the connector 184 is larger than that of the lower portion 116 of the connector 184), and thus the middle portion 114 of the connector 184 is stopped above the bump portion 110 (i.e. the middle portion 114 of the connector 184 can be disposed above the bump portion 110. Also, the upper portion 112 of the connector 184 is disposed outside the first and second through holes 178, 179. The backlight module 170 further includes at least one lamp 174 (e.g. cold cathode fluorescent lamp, CCFL), which has a wire 175, wherein the wire 175 is hold in the upper portion 112 of the connector 184.

The backlight module 170 further includes an inverter 180, which includes a printed circuit board 182 and a transformer (not shown). The printed circuit board 182 is mounted on the lower surface 173 of the bottom plate 176 by a plurality of screws 186. The bottom plate 176 can carry the inverter 180. The printed circuit board 182 is provided with at least one second electrically conductive contact 130, which is located on a top surface 183 of the printed circuit board 182. The second electrically conductive contact 130 is adapted to be connected to the first electrically conductive contact 120 of the lower portion 116 of the connector 184. In this embodiment, the first electrically conductive contact 120 of the lower portion 116 of the connector 184 can be a socket 122 (shown in FIGS. 7 and 8), wherein the socket 122 has at least one hole extended in the direction perpendicular to the bottom surface 118, and the second electrically conductive contact 130 of the printed circuit board 182 can be a plug 132 (shown in FIG. 7). The plug 132 includes a metallic sheet adapted to be inserted into the socket 122. The socket 122 includes a metallic elastic sheet adapted to contact and press the metallic sheet of the plug 132. In another embodiment, on the contrary the first and second electrically conductive contacts 120, 130 can be a plug and a socket (not shown), respectively. The inverter 180 is a DC/AC inverter applied to the backlight module 170 for converting DC voltage into AC voltage and boosting the AC voltage to turn on the lamp 174.

A method for assembling the backlight module 170 in this embodiment of the present invention includes steps as follows. A housing 172 including a bottom plate 176 is provided, wherein the bottom plate 176 includes an upper surface 171, a lower surface 173 and at least one first through opening 178 extended from the upper surface 171 to the lower surface 173. At least one bump portion 110 is disposed on the upper surface 171 of the bottom plate 176, wherein the bump portion 110 includes at least one second through opening 179 communicated with the first through opening 178. Then, a connector 184 including an upper portion 112, a middle portion 114 and a lower portion 116 is provided, wherein the lower portion 116 is provided with a first electrically conductive contact 120, and the middle portion 114 is located between the upper portion 112 and the lower portion 116. The lower portion 116 of the connector 184 faces the upper surface 171 of the bottom plate 176, and is inserted into the first and second through holes 178, 179, whereby the middle portion 114 of the connector 184 is stopped above the bump portion 110, and the upper portion 112 of the connector 184 is disposed outside the first and second through holes 178, 179. Then, a wire 175 of a lamp 174 is hold in upper portion 112 of the connector 184. Finally, the printed circuit board 182 of the inverter 180 is mounted under the bottom plate 176, whereby the second electrically conductive contact 130 is connected to the first electrically conductive contact 120, i.e. a metallic sheet of a plug 132 contacts a metallic elastic sheet of a socket 122.

According to a method for assembling the backlight module 170 in an alternative embodiment of the present invention, the difference is that the printed circuit board 182 of the inverter 180 can be firstly mounted under the bottom plate 176, whereby the second electrically conductive contact 130 is connected to the first electrically conductive contact 120. Then, a wire 175 of a lamp 174 is hold in upper portion 112 of the connector 184. Thus, the order of assembling process of the lamp 174 and the inverter 180 can depend on the requirement.

Referring to FIG. 7 again, in this embodiment, the height of the bump portion 110 is H1, and the distance between the lamp 174 and the bottom plate 176 is E1. The plug 132 is inserted into the socket 122 and the overlapping length between the plug 132 and the socket 122 is D1, in other words, there is an electrical connection between the plug 132 and the socket 122.

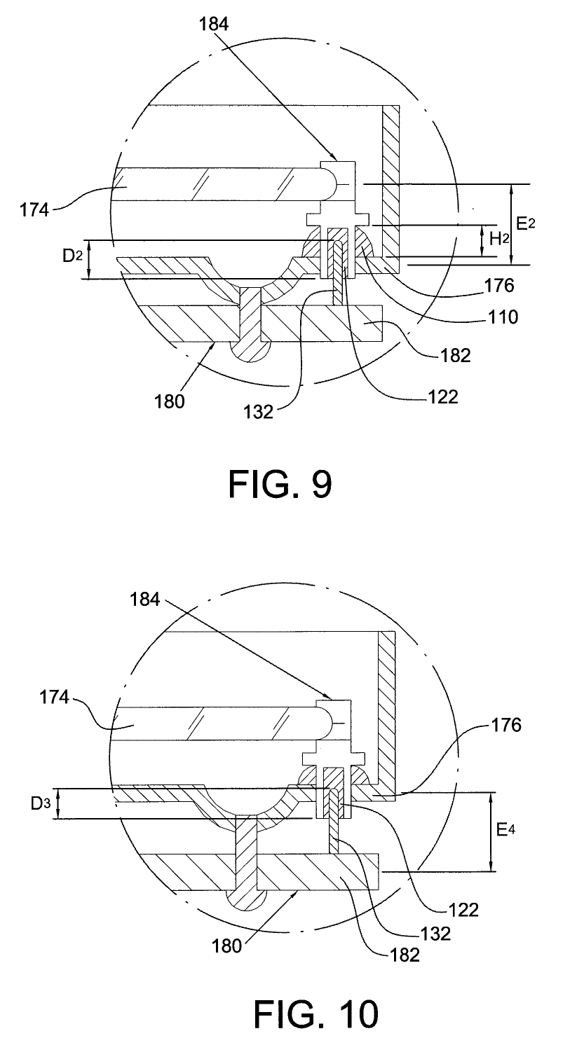

Referring to FIG. 9, in a further embodiment, if the distance between the lamp 174 and the bottom plate 176 is requested to be different from previously mentioned in FIG. 7, the height of the bump portion 110 is just adjusted so as to meet the requirement of different distances. For example, if the distance between the lamp 174 and the bottom plate 176 is requested to be changed from E1 to E2 (E2 is more than E1), then the height of the bump portion 110 is changed from H1 to H2 (H2 is more than H1) accordingly. When the plug 132 is inserted into the socket 122, the overlapping length between the plug 132 and the socket 122 is changed from D1 to D2 (D2 is less than D1) correspondingly. To sum up, as the distance between the lamp 174 and the bottom plate 176 is changed, the height of the bump portion 110 must be adjusted accordingly and the overlapping length between the plug 132 and the socket 122 is different accordingly. But, the above-mentioned adjustment does not affect the electrical connection between the plug 132 and the socket 122. There is still an electrical connection between the plug 132 and the socket 122.

Referring to FIGS. 6 and 7 again, the distance between the printed circuit board 182 of the inverter 180 and the bottom plate 176 is E3. The plug 132 is inserted into the socket 122 in the direction (arrow 133) perpendicular to the bottom plate 176 and the overlapping length between the plug 132 and the socket 122 is D1, it can be sure that the electrical connection between the plug 132 and the socket 122 is good.

Referring to FIG. 10, in another embodiment, if the distance between the printed circuit board 182 of the inverter 180 and the bottom plate 176 is requested to be different from previously mentioned in FIG. 7, the overlapping length between the plug 132 and the socket 122 is different when the plug 132 is inserted into the socket 122. But, the above-mentioned adjustment does not affect the electrical connection between the plug 132 and the socket 122. For example, if the distance between the printed circuit board 182 of the inverter 180 and the bottom plate 176 is changed from E3 to E4 (E4 is more than E3), the overlapping length between the plug 132 and the socket 122is changed from D1 to D3 (D3 is less than D1) when the plug 132 is inserted into the socket 122. Although the overlapping length between the plug 132 and the socket 122 is different, the above-mentioned adjustment does not affect the electrical connection between the plug 132 and the socket 122. There is still an electrical connection between the plug 132 and the socket 122.

According to the connector of the present invention, when the distance between the lamp and the bottom plate is requested to be different or the distance between the printed circuit board of the inverter and the bottom plate is requested to be different, it is not necessary to redesign a new connector having different height or size. Simultaneously, it can be still sure that the electrical connection between the plug of the printed circuit board of the inverter and the socket of the connector is good. Compared with the prior art, the connector of the present invention is an all-purpose connector so as to decrease the manufacture cost of connectors.

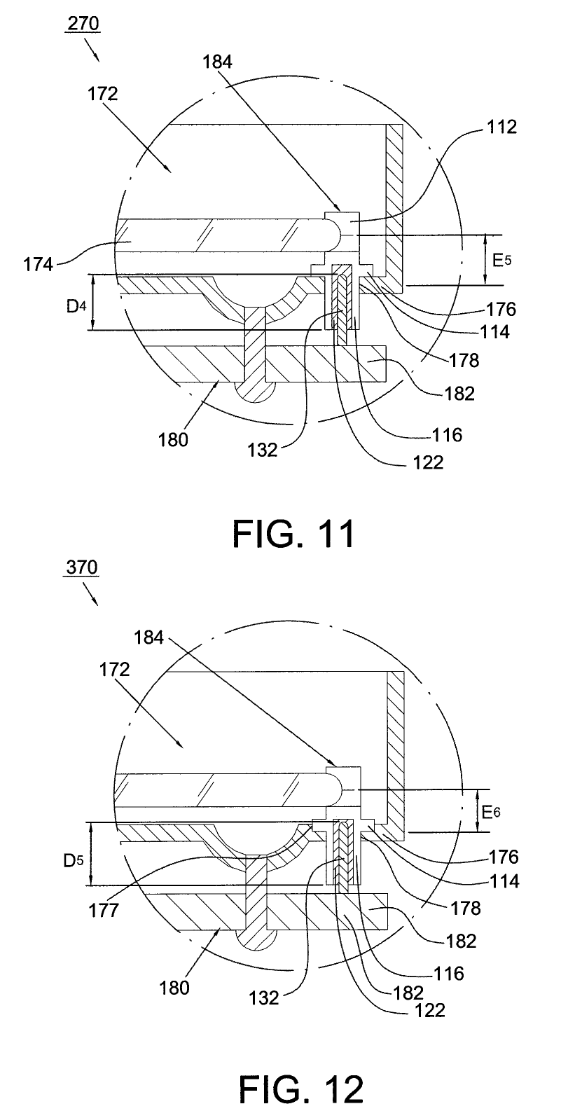

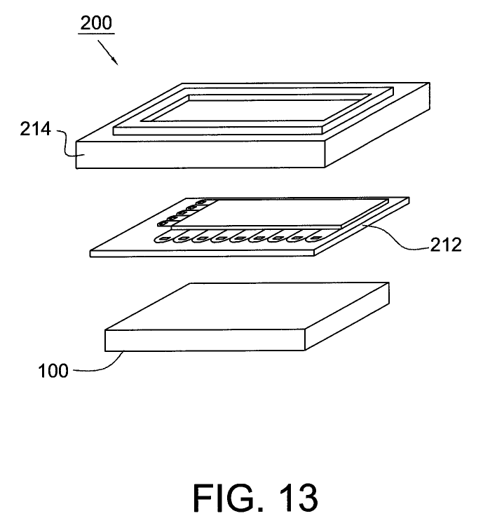

Referring to FIG. 11, it depicts a backlight module 270 according to a second embodiment of the present invention. The backlight module 270 in the second embodiment is substantially similar to the backlight module 170 in the first embodiment, wherein the same elements are designated with the same reference numerals. The difference between the backlight modules 270, 170 is that the housing 172 of the backlight module 270 does not include the bump portion 110. The cross-sectional area of the middle portion 114 of the connector 184 is larger than that of the first through hole 178 (i.e. the cross-sectional area of the middle portion 114 of the connector 184 is larger than that of the lower portion 116 of the connector 184), and thus the middle portion 114 of the connector 184 is stopped above the upper surface 171 of the bottom plate 176, and the upper portion 112 of the connector 184 is disposed outside the first through hole 178 when the lower portion 116 of the connector 184 faces the upper surface 171 of the bottom plate 176 and is inserted into the first through hole 178. Although the overlapping length between the plug 132 and the socket 122 is D4 when the plug 132 is inserted into the socket 122, it can be still sure that the electrical connection between the plug 132 and the socket 122 is good.

Referring to FIG. 12, it depicts a backlight module 370 according to a third embodiment of the present invention. The backlight module 370 in the third embodiment is substantially similar to the backlight module 270 in the second embodiment, wherein the same elements are designated with the same reference numerals. The difference between the backlight modules 370, 270 is that the bottom plate 176 of the housing 172 of the backlight module 370 further includes a concave 177, which is communicated with the first through hole 178 for accommodating the middle portion 114 of the connector 184 (i.e. the cross-sectional area of the concave 177 is not smaller than that of the middle portion 114). In this embodiment, the concave 177 is located on the upper surface 171 of the bottom plate 176, e.g. the concave 177 is formed by milling and grooving the upper surface 171 of the bottom plate 176. In an another embodiment, the concave 177 is formed by bending the upper surface 171 and the lower surface 173 of the bottom plate 176, e.g. the concave 177 is formed by punching the upper surface 171 and the lower surface 173 of the bottom plate 176. The cross-sectional area of the middle portion 114 of the connector 184 is larger than that of the first through hole 178 (i.e. the cross-sectional area of the middle portion 114 of the connector 184 is larger than that of the lower portion 116 of the connector 184), and thus the middle portion 114 of the connector 184 is stopped above the concave 177 of the bottom plate 176, and the upper portion 112 of the connector 184 is disposed outside the first through hole 178 when the lower portion 116 of the connector 184 faces the upper surface 171 of the bottom plate 176 and is inserted into the first through hole 178. Although the overlapping length between the plug 132 and the socket 122 is D4 when the plug 132 is inserted into the socket 122, it can be still sure that the electrical connection between the plug 132 and the socket 122 is good.

In addition, the backlight module 170 of the present invention can be applied to a liquid crystal display device 200. The liquid crystal display device 200 includes a liquid crystal panel 212 and the backlight module 170 of the present invention. The liquid crystal panel 212 is disposed above the backlight module 170 for distributing the light from a light source uniformly over the liquid crystal panel 212. The liquid crystal display device 200 further includes a front frame 214, which is assembled with the backlight module 170 for fixing the liquid crystal panel 212 so as to form the liquid crystal display device 200.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A backlight module comprising:
a housing comprising a bottom plate, which comprises an upper surface, a lower surface and at least one first through opening; and
at least one connector comprising an upper portion, a middle portion and a lower portion, wherein the lower portion is disposed within the first through hole and is provided with a first electrically conductive contact, the middle portion is located between the upper portion and the lower portion, and the middle portion is stopped over the upper surface of the bottom plate.

2. The backlight module as claimed in claim 1, wherein the housing further comprises at least one bump portion disposed on the upper surface of the bottom plate, the bump portion comprises at least one second through opening communicated with the first through opening, and the middle portion of the connector is disposed above the bump portion.

3. The backlight module as claimed in claim 1, wherein the bottom plate further comprises a concave, which is communicated with the first through hole.

4. The backlight module as claimed in claim 1, wherein the concave is located on the upper surface of the bottom plate.

5. The backlight module as claimed in claim 1, wherein the concave is formed by bending the upper surface and the lower surface of the bottom plate.

6. The backlight module as claimed in claim 1, further comprising:
an inverter comprising a printed circuit board mounted on the lower surface of the bottom plate, the printed circuit board being provided with at least one second electrically conductive contact adapted to be connected to the first electrically conductive contact.

7. The backlight module as claimed in claim 6, further comprising:
at least one lamp having a wire, the wire being hold in the upper portion of the connector.

8. The backlight module as claimed in claim 6, wherein the first and second electrically conductive contacts are a socket and a plug, respectively.

9. The backlight module as claimed in claim 6, wherein the first and second electrically conductive contacts are a plug and a socket, respectively.

10. The backlight module as claimed in claim 8, wherein the plug comprises a metallic sheet.

11. The backlight module as claimed in claim 10, wherein the socket comprises a metallic elastic sheet.

12. The backlight module as claimed in claim 1, wherein the cross-sectional area of the middle portion of the connector is larger than those of the first and second through holes.

13. The backlight module as claimed in claim 1, wherein the cross-sectional area of the middle portion of the connector is larger than that of the lower portion of the connector.

14. The backlight module as claimed in claim 1, wherein the lower portion of the connector has a bottom surface, and the electrically conductive contact is located on the bottom surface of the lower portion.

15. The backlight module as claimed in claim 6, wherein the printed circuit board has a top surface, and the second electrically conductive contact is located on the top surface of the printed circuit board.

16. The backlight module as claimed in claim 2, wherein the bump portion is detachably mounted on the upper surface of the bottom plate.

17. The backlight module as claimed in claim 2, wherein the bump portion and the bottom plate are integrated formed.

18. The backlight module as claimed in claim 8, wherein the socket has at least one hole extended in the direction perpendicular to the bottom surface.

19. A connector comprising:
an upper portion;
a lower portion having a bottom provided with an electrically conductive contact; and
a middle portion located between the upper portion and the lower portion, wherein the cross-sectional area of the middle portion is larger than that of the lower portion.

20. The connector as claimed in claim 19, wherein the electrically conductive contact is a plug.

21. The connector as claimed in claim 20, wherein the plug comprises a metallic sheet.

22. The connector as claimed in claim 19, wherein the electrically conductive contact is a socket.

23. The connector as claimed in claim 22, wherein the socket comprises a metallic elastic sheet.

24. A liquid crystal display device comprising:
a backlight module comprising:
a housing comprising a bottom plate, which comprises an upper surface, a lower surface and a first through opening; and
a connector comprising an upper portion, a middle portion and a lower portion, wherein the lower portion is disposed within the first through hole and is provided with a first electrically conductive contact, the middle portion is located between the upper portion and the lower portion, and the middle portion is disposed over the upper surface of the bottom plate;
a liquid crystal panel disposed above the backlight module; and
a front frame assembled with the backlight module for forming the liquid crystal display device.

25. The liquid crystal display device as claimed in claim 24, wherein the housing further comprises at least one bump portion disposed on the upper surface of the bottom plate, the bump portion comprises at least one second through opening communicated with the first through opening, and the middle portion of the connector is disposed above the bump portion.

26. The liquid crystal display device as claimed in claim 24, wherein the bottom plate further comprises a concave, which is communicated with the first through hole for accommodating the middle portion of the connector.

27. The liquid crystal display device as claimed in claim 26, wherein the concave is located on the upper surface of the bottom plate.

28. The liquid crystal display device as claimed in claim 26, wherein the concave is formed by bending the upper surface and the lower surface of the bottom plate.

29. The liquid crystal display device as claimed in claim 24, further comprising:
an inverter comprising a printed circuit board mounted on the lower of the bottom plate, the printed circuit board being provided with at least one second electrically conductive contact adapted to be connected to the first electrically conductive contact.

30. The liquid crystal display device as claimed in claim 29, further comprising:
at least one lamp having a wire, the wire being hold in the upper portion of the connector.
